(19) United States
(12) Patent Application Publication
(10) Pub. No.: US 2026/0184304 A1
(43) Pub. Date: Jul. 2, 2026

(54) VEHICULAR DRIVING ASSIST SYSTEM WITH TRAJECTORY PLANNING FOR COLLISION AVOIDANCE

(71) Applicant: Magna Electronics Inc., Auburn Hills, MI (US)

(72) Inventor: Jason R. Zalev, Thornhill (CA)

(21) Appl. No.: 19/430,660

(22) Filed: Dec. 23, 2025

Related U.S. Application Data
(60) Provisional application No. 63/739,139, filed on Dec. 27, 2024.

(51) Int. Cl. B60W 30/09; B60W 10/20

(52) U.S. Cl. CPC B60W 30/09; B60W 10/20; B60W 2510/20; B60W 2520/10; B60W 2530/201; B60W 2710/205; B60W 2720/10

(57) ABSTRACT

A vehicular driving assist system, includes a sensor disposed at a vehicle equipped with the vehicular driving assist system and sensing exterior of the vehicle that captures sensor data. The vehicular driving assist system detects, responsive to processing at an ECU of sensor data captured by the sensor, an object in the field of sensing. The vehicular driving assist system determines, based at least in part on detecting the object, a plurality of waypoints that represents a reference trajectory of the vehicle. The vehicular driving assist system determines, for each waypoint of the plurality of waypoints, a constraint with respect to the detected object. The vehicular driving assist system adjusts, based at least in part on the constraints with respect to the detected object, the reference trajectory of the vehicle to determine an updated trajectory of the vehicle.

### CROSS REFERENCE TO RELATED APPLICATION

The present application claims the filing benefits of U.S. provisional application Ser. No. 63/739,139, filed Dec. 27, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driving assist system includes a sensor disposed at a vehicle equipped with the vehicular control system and sensing exterior of the vehicle. The sensor capturing sensor data. An electronic control unit (ECU) comprises electronic circuitry and associated software. The electronic circuitry of the ECU comprises a processor for processing sensor data captured by the sensor to detect presence of objects in a field of sensing of the sensor. The ECU or vehicular driving assist system detects, responsive to processing by the processor of sensor data captured by the sensor, an object in the field of sensing. The ECU or vehicular driving assist system determines, based at least in part on determining the object, a plurality of waypoints that represents a reference trajectory of the vehicle. The ECU or vehicular driving assist system determines, for each waypoint of the plurality of waypoints, a constraint with respect to the detected object. The ECU or vehicular driving assist system may adjust the reference trajectory of the vehicle based at least in part on the constraints with respect to the object to determine an updated trajectory of the vehicle. The ECU or vehicular driving assist system may determine, for each waypoint of the plurality of waypoints, a constraint with respect to a determined region within the field of sensing where an object may be detected.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates sensors;

FIG. 2 is a spatial map of a vehicle with a sensing system that incorporates sensors;

FIG. 3A is a spatial map illustrating a generated trajectory of a path for a rear-in perpendicular parking maneuver of a vehicle into a perpendicular parking slot;

FIG. 3B is a series of graphs illustrating state and control variables corresponding to a generated trajectory of a rear-in perpendicular parking maneuver of a vehicle;

FIG. 4A is a spatial map illustrating a generated trajectory of a path for a rear-in parallel parking maneuver of a vehicle into a parallel parking slot;

FIG. 4B is a series of graphs illustrating state and control variables corresponding to a generated trajectory of a rear-in parallel parking maneuver of a vehicle.

FIG. 5A is a spatial map illustrating a generated trajectory of a path for a parallel park-in maneuver of a vehicle into a parallel parking slot; and

FIG. 5B is a series of graphs illustrating state and control variables corresponding to a generated trajectory of a parallel park-in maneuver of a vehicle.

### DESCRIPTION OF THE PREFERRED EMBODIMENTS

A vehicle vision system and/or driver or driving assist system and/or object detection system and/or alert system and/or control system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

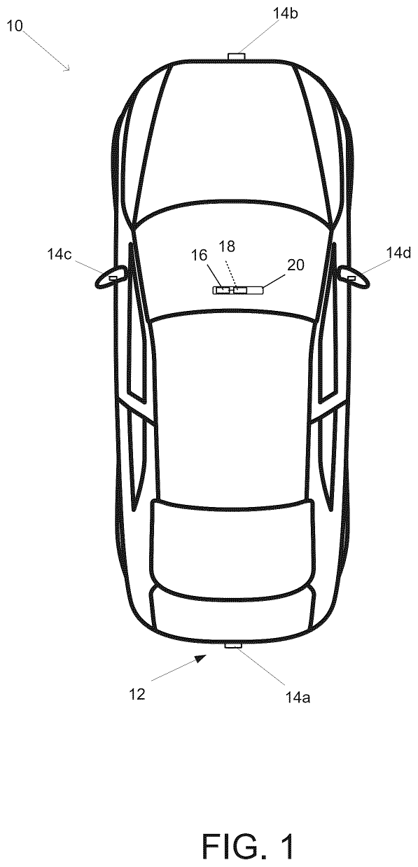

Referring now to the drawings and the illustrative embodiments depicted therein, a vehicle 10 includes a sensing system or driving assist system 12 that includes at least one exterior sensing sensor, such as an exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle 10, and a sideward/rearward viewing camera 14c, 14d at respective sides of the vehicle 10), which captures images exterior of the vehicle 10, with the camera having a lens for focusing images at or onto an imaging array or imaging plane or imager of the camera (FIG. 1). Optionally, a forward viewing camera may be disposed at the windshield of the vehicle 10 and view through the windshield and forward of the vehicle 10, such as for a machine vision system (such as for traffic sign recognition, headlamp control, pedestrian detection, collision avoidance, lane marker detection and/or the like). Additionally or alternatively, the system 12 may also include non-imaging sensors, such as radar sensors, lidar sensors, and/or ultrasonic sensors, to further determine locations and distances of objects proximate to the vehicle 10. The vision system 12 includes a control or electronic control unit (ECU) 18 having electronic circuitry and associated software, with the electronic circuitry including a data processor or image processor that is operable to process image data captured by the camera or cameras, whereby the ECU or system may detect or determine presence of objects or the like and/or the system provide displayed images at a display device 16 for viewing by the driver of the vehicle 10 (although shown in FIG. 1 as being part of or incorporated in or at an interior rearview mirror assembly 20 of the vehicle 10, the control and/or the display device may be disposed elsewhere at or in the vehicle 10). The data transfer or signal communication from the camera to the ECU may comprise any suitable data or communication link, such as a vehicle network bus or the like of the equipped vehicle 10.

To maneuver a vehicle equipped with autonomous driving capabilities, in scenarios such as parallel or perpendicular parking, a control system of the equipped vehicle often continually adjusts speed and steering inputs to guide the equipped vehicle along a generated path. Accordingly, the quality of the generated path is a limiting factor in maneuvering performance of the equipped vehicle. While most trajectory planning (i.e., path planning) approaches include determining a collision-free route, optimal trajectory planning involves optimizing transitions from initial to final states. For example, trajectory planning optimization may involve minimizing, via a kinematic model, maneuvering of the equipped vehicle over all potential trajectories (i.e., paths). That is, trajectory planning optimization may involve minimizing the action over all paths permitted by a kinematic model. Sequential convex optimization may improve flexibility and efficiency of optimal trajectory generation. Including sequential convex optimization in a vehicular control system may reduce computation time, minimize the distance of the path, and minimize the number of path segments to maneuver the equipped vehicle across a desired path or destination, all while avoiding blind-spots of the sensors of the equipped vehicle. Vehicle kinematics may be represented by a discretized Dubins model. To avoid collisions of the equipped vehicle with objects in the environment of the equipped vehicle, the vehicular control system may constrain each waypoint of the trajectory by linear inequalities representing closest distance of the objects to a polygon representation of the equipped vehicle. To determine smooth and valid trajectories, the determined kinematic state and control variables are constrained and regularized by penalty terms in the Dubins model's cost function, which enforces physical restrictions such as limiting a steering angle, acceleration, and speed of the equipped vehicle. The vehicular control system may determine the trajectory of the equipped vehicle in various parking scenarios, including parallel and perpendicular parking. Vehicular control systems including sequential convex optimization may generate and/or determine efficient and collision-free motion of the equipped vehicle.

In vehicular control systems that perform autonomous parking maneuvers of the equipped vehicle, sensors of the equipped vehicle continuously capture data regarding objects proximate to the equipped vehicle, including the presence of pedestrians, barriers, curbs, lane markings, and other vehicles. During parking of the equipped vehicle, the vehicular control system considers the proximity of the equipped vehicle to the objects in order to determine a collision-free trajectory for maneuvering the equipped vehicle into or out of a parking slot. Because the geometry of a slot can vary in different parking scenarios and environments, the vehicular control system should be flexible in its approach to determining the trajectory to ensure optimal trajectory planning across the various scenarios.

Maneuvering approaches for vehicular control systems may fall into one of two categories: (i) direct methods, where the path and trajectory are determined simultaneously, and (ii) indirect methods, where maneuvers are split into stages of path planning and path following. Indirect methods may use heuristics with efficient computation to determine a feasible path, but the resulting trajectory may be sub-optimal. Example indirect methods include geometric planners, which may involve creating simple paths using spline curves or circular arcs and segments. Example Direct methods may involve higher computation (i.e., higher complexity computation) to solve optimal trajectories or use fast approximations. Alternatively, a vehicular control system may use sequential convex optimization (e.g., via processing by the ECU) to include non-linear constraints and objectives in the computations. For real-time applications, model predictive control (MPC) involves performing dynamic updates to path and trajectory, optimizing over a short time horizon for improved efficiency.

The vehicular control system including sequential convex optimization may provide for optimal trajectory planning and collision avoidance for vehicles that include autonomous driving capabilities. Objects proximate to the equipped vehicle are represented within the vehicular control system by rectangular regions. A trajectory includes a series of waypoints that specify the kinematic state of the equipped vehicle (i.e., host vehicle). The equipped vehicle has a rectangular shape, which the vehicular control system represents with a convex polygon to fill gaps in the trajectory curvature determined by the vehicular control system. Constraints to avoid collision are based on determining the closest distance of the polygon to each rectangular object, and penalizing waypoints that cause an overlap between the polygon and each rectangular object. Sequential convex optimization minimizes the total elapsed time required for the equipped vehicle to execute the trajectory. Kinematic state variables are limited by upper and lower bounds, which provides flexibility to control characteristics of the resulting trajectory. Additional smoothness constraints may regularize the trajectory and may contribute to faster convergence. The vehicular control system including sequential convex optimization may include special constraints to avoid blind spots (i.e., gaps in sensing of the surroundings of the equipped vehicle) in the sensing system of the equipped vehicle. Accordingly, the low-visibility regions may be detected by sensors along the trajectory, avoiding potential collisions.

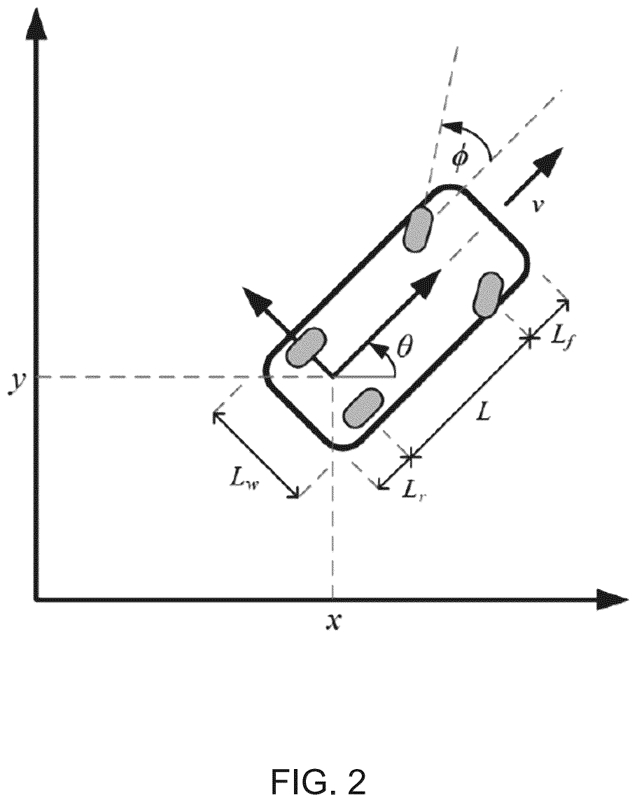

FIG. 2 illustrates dimensions of the equipped vehicle, which are used by the vehicular control system to perform calculations regarding position of the equipped vehicle and proximity of objects proximate to the equipped vehicle. The dimensions of the equipped vehicle include: L, a wheelbase; L_{f}, a front overhang; Lᵣ, a rear overhang; L_{w}, a width of the vehicle. An orientation of the equipped vehicle within its environment is represented by θ, the angle between the longitudinal axis of the vehicle and a fixed axis, y. A steering angle of a steering system of the vehicle is represented by φ. A velocity vector v represents a speed and direction of travel of the equipped vehicle.

The trajectory of the equipped vehicle may be modeled using kinematic state vector x(t) and control input vector u(t), according to Equation (1).

$$x ( t ) = [ \begin{matrix}x ( t ) \\ y ( t ) \\ v ( t ) \\ a ( t ) \\ θ ( t ) \\ ϕ ( t )\end{matrix} ] , \qquad ( 1 )$$

$$u ( t ) = [ \begin{matrix}j ( t ) \\ ω ( t )\end{matrix} ]$$

Here, x(t) and y(t) represent two-dimensional (2D) position coordinates, v(t) represents velocity of the equipped vehicle, a(t) represents acceleration of the equipped vehicle, θ(t) represents orientation of the equipped vehicle, φ(t) represents steering angle of the equipped vehicle, ω(t) represents steering rate of the equipped vehicle, and j(t) represents jerk (i.e., the rate of change of acceleration) of the equipped vehicle.

A state space function ƒ(x(t), u(t), p) is constructed by specifying the time-derivative of x(t), represented by Equation (2).

$$f ( x ( t ) , u ( t ) , p ) = \frac{d x ( t )}{d t} = [ \begin{matrix}v ( t ) cos θ ( t ) \\ v ( t ) sin θ ( t ) \\ a ( t ) \\ j ( t ) \\ \frac{v ( t ) tan ϕ ( t )}{L} \\ ω ( t )\end{matrix} ] \qquad ( 2 )$$

Equation (2) constrains the dynamics of motion of the equipped vehicle and should be satisfied by any valid trajectory. Here, the vector p corresponds to parameters that may be adjusted in the model. The constant L represents the wheelbase of the equipped vehicle.

Because Equation (2) is non-linear, it yields a non-convex optimization problem that is difficult to solve directly. Therefore, to compute the trajectory, the sequential convex optimization (described below) may be used to approximate the original non-convex problem with an iterative sequence of convex sub-problems. Each sub-problem is obtained by linearizing the trajectory with respect to a reference solution, corresponding to the output of the previous iteration.

Accordingly, Equation (2) may be linearized with respect to (x̅, ū, p̅), represented by Equations (3a) and 3b).

$$\begin{matrix}\frac{dx ( t )}{dt} = f ( x ( t ) , u ( t ) , p ) \\ \approx f ( \overline{x} ( t ) , \overline{u} ( t ) , \overline{p} ) + A ( t ) [ x ( t ) - \overline{x} ( t ) ] + B ( t ) [ u ( t ) - u ( t ) ] + E ( t ) [ p - \overline{p} ]\end{matrix} \qquad ( 3 a )$$

$$= [ A ( t ) B ( t ) E ( t ) ] [ \begin{matrix}x ( t ) \\ u ( t ) \\ p\end{matrix} ] + \overline{r} ( t ) \qquad ( 3 b )$$

Here, r̅(t) is represented by Equation (3c), and A(t), B(t), and E(t) are represented by Equations (4a), (4b), and (4c).

$$\overline{r} ( t ) = f ( \overline{x} , \overline{u} , \overline{p} ) - A ( t ) \overline{x} ( t ) - B ( t ) \overline{u} ( t ) - E ( t ) \overline{p} \qquad ( 3 c )$$

$$A ( t ) = {∇}_{x} f ( \overline{x} ( t ) , \overline{u} ( t ) , \overline{p} ) \qquad ( 4 a )$$

$$B ( t ) = {∇}_{u} f ( \overline{x} ( t ) , \overline{u} ( t ) , \overline{p} ) \qquad ( 4 b )$$

$$E ( t ) = {∇}_{p} f ( \overline{x} ( t ) , \overline{u} ( t ) , \overline{p} ) . \qquad ( 4 c )$$

In Equation (3b), the reference components x̅(t), u(t), and p of Equation (3a) have been collected into an overall reference vector r̅(t), defined in Equation (3c). Accordingly, Equation (3b) isolates the current trajectory, which is solved in each iteration. Because A(t), B(t), E(t), and r̅(t) depend only on the reference components, Equations (3c) and (4a-c) may act as constants that are pre-computed for each iteration.

To solve the trajectory, Equation (1) is converted to a discretized form, represented by state variable xₖ=[xₖ, yₖ, vₖ, aₖ, θₖ, φₖ]^{T} with control variable uₖ=[jₖ, ωₖ]^{T}, where k=1 . . . N. Here, the discrete index k corresponds to the continuous time variable t=(k−1)Δt, where

$$Δ t = \frac{{t}_{f}}{N} .$$

The trajectory corresponds to N waypoints with uniform temporal spacing, where t_{ƒ} is the time required to reach the final state of the trajectory (i.e., a final location or destination of the vehicle). For discretization, t_{ƒ} is included in the parameter set p, allowing it to be solved as an unknown model variable.

For convenience, we concatenate xₖ and uₖ into the stacked vectors \tilde{x} and ũ, according to Equations (5a), (5b), and (5c).

$$\tilde{x} = v e c ( {x}_{1} , {x}_{2} , … , {x}_{N} ) , \qquad ( 5 a )$$

$$\tilde{u} = vec ( {u}_{1} , {x}_{2} , … , {u}_{N} ) , \qquad ( 5 b )$$

$$\tilde{p} = {t}_{f} . \qquad ( 5 c )$$

Using the stacked vectors from Equations (5a-c), a discretized kinematic state equation, analogous to Equation (3b), can be represented by Equation (6).

$${\underbrace{[ \begin{matrix}\tilde{A} & \tilde{B} & \tilde{C}\end{matrix} ]}}_{K} [ \begin{matrix}\tilde{x} \\ \tilde{u} \\ \tilde{p}\end{matrix} ] + \tilde{r} = 0 \qquad ( 6 )$$

Here, \tilde{r}=vec(\tilde{r}₁, . . . , \tilde{r}_{N}) is the stacked reference vector, and K=[Ã, \tilde{B}, \tilde{E}] is an overall kinematic matrix, where Ã, \tilde{B}, \tilde{E} are represented by Equations (7a), (7b), and (7c).

$$\tilde{A} = [ \begin{matrix}{A}_{1} & - 1 & 0 & … & 0 \\ 0 & ⋱ & ⋱ & & ⋮ \\ ⋮ & & ⋱ & ⋱ & 0 \\ 0 & … & 0 & {A}_{N} & - 1\end{matrix} ] \qquad ( 7 a )$$

$$\tilde{B} = [ \begin{matrix}{B}_{1}^{-} & {B}_{1}^{+} & 0 & … & 0 \\ 0 & ⋱ & ⋱ & & ⋮ \\ ⋮ & & ⋱ & ⋱ & 0 \\ 0 & … & 0 & {B}_{N}^{-} & {B}_{N}^{+}\end{matrix} ] \qquad ( 7 b )$$

$$\tilde{E} = [ \begin{matrix}{E}_{1} \\ ⋮ \\ {E}_{N}\end{matrix} ] \qquad ( 7 c )$$

Equations (7a-c) are obtained by considering the discrete form of Equation (3b), which can be represented by Equation (8).

$${x}_{k + 1} = [ \begin{matrix}{A}_{k} & {B}_{k}^{-} & {B}_{k}^{+} & {E}_{k}\end{matrix} ] [ \begin{matrix}{x}_{k} \\ {u}_{k} \\ {u}_{k + 1} \\ p\end{matrix} ] + {r}_{k} \qquad ( 8 )$$

Expanding for each k, and representing Equation (8) in matrix form results in Equation (7). Here, Aₖ describes the control-free transition from state xₖ to xₖ₊₁. A first-order hold is used to interpolate between control inputs uₖ and uₖ₊₁, involving the two control matrices

$${B}_{k}^{-} and {B}_{k}^{+}$$

The matrix Eₖ determines the effect of p on the state transition, and rₖ describes the reference component.

In the above equations, Aₖ, Bₖ, Eₖ and rₖ involve transition over the interval k to k+1. To evaluate Aₖ, Bₖ, Eₖ and rₖ, the state transition matrix φ(t, t₀) may be used, where φ(t, t₀) may be determined by a recursive numerical computation of Equation (9a).

$$Φ ( t , {t}_{0} ) = I + {\int }_{{t}_{0}}^{t} A ( t ) Φ ( t , {t}_{0} ) d t , \qquad ( 9 a )$$

Here, t increases in small steps, starting from t₀, until t=t₀+Δₜ, with an initial matrix Φ(t₀, t₀)=1.

Equation (9a) may be replaced with Φ(τ, τₖ). Thus, the domain changes from t to τ, where

$${τ}_{k} = \frac{k - 1}{N} ,$$

which captures the impact of parameter t_{ƒ} on the state transition, scaling t while keeping N fixed. The substitution of Φ(t₀, t₀)=I for Φ(τ, τₖ) may be represented by Equation (9b).

$$Φ ( τ , {τ}_{k} ) = I + {t}_{f} {\int }_{{τ}_{k}}^{{τ}_{k + 1}} A ( {t}_{f} τ ) Φ ( τ , {τ}_{k} ) d τ , \qquad ( 9 b )$$

Here, t=t_{ƒ}τ and

$$d t = \frac{d t}{d τ} d τ = {t}_{f} d τ .$$

Equation (9b) may be used to evaluate the discretization matrices, as represented Equations (10a), (10b), (10c), (10d), and (10e).

$${A}_{k} = Φ ( {τ}_{k + 1} , {τ}_{k} ) \qquad ( 10 a )$$

$${B}_{k}^{-} = {t}_{f} {A}_{k} {\int }_{{τ}_{k}}^{{τ}_{k + 1}} {Φ}^{- 1} ( τ , {τ}_{k} ) B ( {t}_{f} τ ) {η}_{-} ( τ ) d τ \qquad ( 10 b )$$

$${B}_{k}^{+} = {t}_{f} {A}_{k} {\int }_{{τ}_{k}}^{{τ}_{k + 1}} {Φ}^{- 1} ( τ , {τ}_{k} ) B ( {t}_{f} τ ) {η}_{+} ( τ ) d τ \qquad ( 10 c )$$

$${E}_{k} = {t}_{f} {A}_{k} {\int }_{{τ}_{k}}^{{τ}_{k + 1}} {Φ}^{- 1} ( τ , {τ}_{k} ) E ( {t}_{f} τ ) d τ \qquad ( 10 d )$$

$${r}_{k} = {t}_{f} {A}_{k} {\int }_{{τ}_{k}}^{{τ}_{k + 1}} {Φ}^{- 1} ( τ , {τ}_{k} ) \overline{r} ( {t}_{f} τ ) d τ . \qquad ( 10 e )$$

### Here,

$${η}_{+} ( τ ) = \frac{τ - {τ}_{k}}{Δ τ} and {η}_{-} ( τ ) = \frac{{τ}_{k + 1} - τ}{Δ τ}$$

are used for linear interpolation of

$${B}_{k}^{-} and {B}_{k}^{+} ,$$

where Δτ=τₖ₊₁−τₖ. Equations (10a-e) may be solved by evaluating Equation (4a-c), which may be represented by Equations (11a-c).

$$A ( t ) = [ \begin{matrix}0 & 0 & cos θ & 0 & - v sin θ & 0 \\ 0 & 0 & sin θ & 0 & - v cos θ & 0 \\ 0 & 0 & 0 & 1 & 0 & 0 \\ 0 & 0 & 0 & 0 & 0 & 0 \\ 0 & 0 & \frac{tan ϕ}{L} & 0 & 0 & 0 \\ 0 & 0 & 0 & 0 & \frac{v}{L} {sec}^{2 ϕ} & 0 \\ 0 & 0 & 0 & 0 & 0 & 0\end{matrix} ] \qquad ( 11 a )$$

$$B ( t ) = [ \begin{matrix}0 & 0 \\ 0 & 0 \\ 0 & 0 \\ 1 & 0 \\ 0 & 0 \\ 0 & 1\end{matrix} ] \qquad ( 11 b )$$

$$E ( t ) = f ( x ( t ) , u ( t ) , p ) \qquad ( 11 c )$$

The matrix in Equation (11a) depends on states v(t), θ(t), and φ(t) of x(t) according to Equation (1). To compute Equation (10a-e) and Equation (11a-c), a Runge-Kutta method may be used to perform numerical integration of Equation (9b) in small steps. Over the interval τₖ to τₖ₊₁, the state vector may be determined by x(t_{ƒ}τ)=Φ(τ, τₖ)xₖ, and the control vector may be interpolated as u(t_{ƒ}τ)=η₊(τ)uₖ+η₋(τ)uₖ₋₁.

To obtain an optimal trajectory, a linearized form of Equation (6) may be evaluated with the unknown vector variable z=vec(\tilde{x}, ũ, \tilde{p}). In sequential convex optimization, a non-convex optimization problem, represented by Equation (12a) can be approximated with a converging sequence of convex sub-problems, represented by Equation (12b).

$${minimize g ( z )}_{z} \qquad ( 12 a )$$

$$subject to h ( z ) \leq 0$$

$${z}^{( i + 1 )} = {z}^{( i )} + arg {min}_{Δz ∈ {𝒦}_{t}} ∇ {g ( {z}^{( i )} )}^{T} Δ zsubject to ∇ {h ( {z}^{( i )} )}^{T} Δ z \leq - h ( {z}^{( i )} ) , \qquad ( 12 b )$$

Here, z⁽ⁱ⁺¹⁾ is the solution of iteration i+1. The non-linear objective g(z) and constraint h(z) of Equation (12a) are linearized in Equation (12b) by computing gradients ∇g(z) and ∇h(z) with respect to previous solution z⁽ⁱ⁾ (starting with initial solution z⁽⁰⁾).

In Equation (12b), the unknown variable Δz, which is solved, corresponds to the change in solution z⁽ⁱ⁺¹⁾−z⁽ⁱ⁾, updating the result in each iteration. This sequence of solutions will converge to a local minimum when Δz is confined to a suitable trust region [symbol] anchored at z⁽ⁱ⁾. A penalized trust region for [symbol] can be implemented using an α-weighted norm ∥Δz∥_{α} where α specifies a weighting between elements of Δz. The weighting is selected to normalize each element to its range of valid parameters, scaling the step-sizes along individual dimensions for improved convergence. The weights may be dynamically adjusted based on vehicle speed or environment type.

To solve an optimal trajectory, Equation (12) with the i-th iteration specified by Equations (13a-f).

$$[ \begin{matrix}{\tilde{x}}^{i + 1} \\ {\tilde{u}}^{i + 1} \\ {t}_{f}^{i + 1}\end{matrix} ] = arg {min}_{\tilde{x} , \tilde{u} , {t}_{f}} {t}_{f} + φ ( \tilde{x} , \tilde{u} ) + {‖ \begin{matrix}\tilde{x} - {\tilde{x}}^{i} \\ \tilde{u} - {\tilde{u}}^{i} \\ {t}_{f} - {t}_{f}^{i}\end{matrix} ‖}_{α}^{2} \qquad ( 13 a )$$

$$subject to K [ \begin{matrix}\tilde{x} \\ \tilde{u} \\ {t}_{f}\end{matrix} ] + \tilde{r} = 0 \qquad ( 13 b )$$

$$M \tilde{x} + b \leq 0 \qquad ( 13 c )$$

$${x}_{1} = {x}_{init} , {u}_{N} = {u}_{final} \qquad ( 13 d )$$

$${u}_{1} = {u}_{init} , {x}_{N} = {x}_{f inal}$$

$$[ \begin{matrix}{x}_{min} \\ {u}_{min}\end{matrix} ] \leq [ \begin{matrix}{x}_{k} \\ {u}_{k}\end{matrix} ] \leq [ \begin{matrix}{x}_{max} \\ {u}_{max}\end{matrix} ] \qquad ( 13 e )$$

$${t}_{f}^{min} \leq {t}_{f} \leq {t}_{f}^{max} \qquad ( 13 f )$$

The first term of Equation (13a) minimizes the time to reach final state t_{ƒ}. The second term φ(\tilde{x}, ũ) is used to regularize the state and control variables, promoting smoothness of the trajectory and minimizing energy used in the trajectory. Regularizing the state and control variables also results in faster convergence. The third term ∥·∥_{α} penalizes results far from the previous solution, with each variable weighted by vector α. Equation (13b) is an equality constraint to ensure valid dynamics corresponding to Equation (6). Collision avoidance is implemented with Equation (13c). Equation (13d) is used to fix the position of the initial and final waypoints and control variables. Equation (13e) ensures that each state and control variable is bounded between minimum and maximum values for k=1 . . . N. Equation (13f) sets limits on t_{ƒ}.

Formulating the collision avoidance constraints of Equation (13c) involves specifying one constraint for each waypoint with respect to each object. In each iteration of Equations (13a-f), it is efficient to compute dₖⱼ, the closest distance from the j-th object to the polygonal boundary surrounding waypoint xₖ.

A positive value for dₖⱼ indicates the vehicle is a safe distance from the object, whereas a negative value for dₖⱼ indicates collision with the object. An individual constraint is represented by Equation (14).

$${d}_{k j} + ∇ {d}_{kj}^{T} {x}_{k} \geq 0 , \qquad ( 14 )$$

Here, the gradient ∇dₖⱼ, taken with respect xₖ, represents how variations in the state variables impact distance to the object (described below).

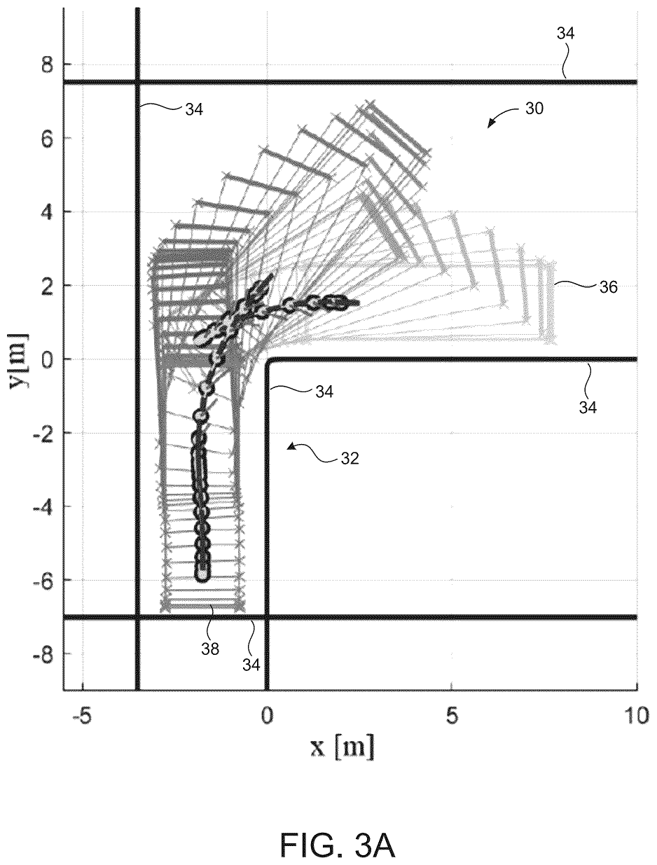

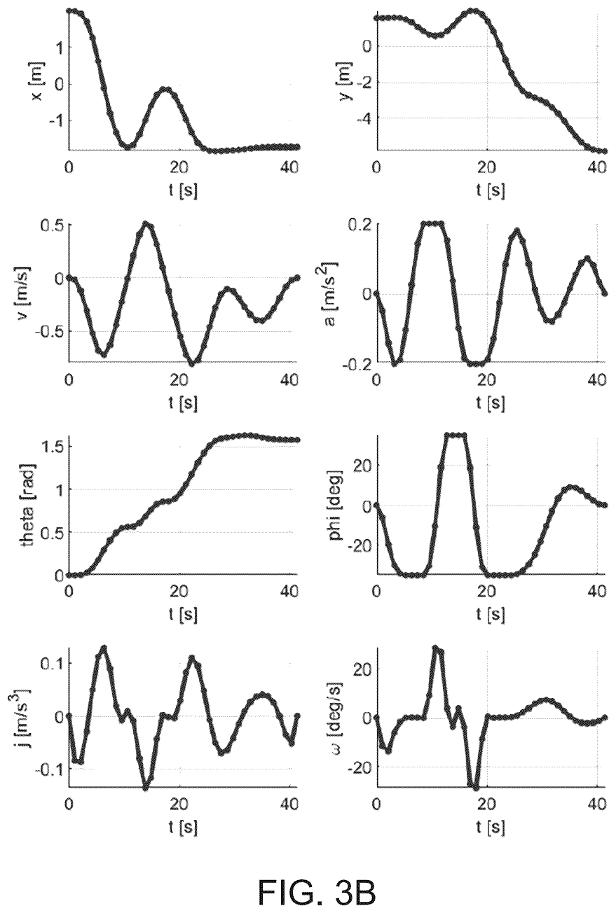

For collision avoidance, using a polygonal boundary permits filling of gaps that result from sampling and curvature of successive waypoints, such as illustrated in FIGS. 3A, 4A, and 5A (discussed below), where gaps or spacing between adjacent rectangles creates a “sawtooth” pattern. To fill in the gaps, polygon k is taken as the convex hull of two rectangles at adjacent waypoints xₖ and xₖ₊₁, transformed according to the position and orientation of the vehicle. Accordingly, an interpolation of the path of the equipped vehicle between two respective waypoints is determined. As illustrated in FIG. 2, the vehicle has length L+L_{f}+Lᵣ and width L_{w}, where L_{f} and Lᵣ are the front and rear overhang and L is the wheelbase.

The vehicle polygon consists of a list of edges and vertices that surround waypoint k. The j-th object is represented by a rectangle, with center position (xⱼ, yⱼ), length aⱼ, width bⱼ, and orientation ψⱼ. To compute the closest point between the polygon and the j-th object efficiently, the polygon is rotated into the principal coordinate frame of the j-th object, according to Equation (15).

$$[ \begin{matrix}{g}_{x} \\ {g}_{y}\end{matrix} ] {p}_{x} = {R}^{- 1 ( {ψ}_{j} ) [ \begin{matrix}{p}_{x} - {x}_{j} \\ {p}_{y} - {y}_{j}\end{matrix} ]} \qquad ( 15 )$$

Here, (pₓ, p_{y}) is a polygon vertex. The rotation matrix is represented by Equation (16).

$$R ( {ψ}_{j} ) = [ \begin{matrix}cos ( {ψ}_{j} ) & - sin ( {ψ}_{j} ) \\ sin ( {ψ}_{j} ) & cos ( {ψ}_{j} )\end{matrix} ] \qquad ( 16 )$$

When the polygon does not intersect the rectangle, the closest point (\tilde{g}ₓ, \tilde{g}_{y}) between the polygon and the rectangle is determined by identifying the minimum distance between the edges of the polygon and the sides of the rectangle using separating-axis projections. If any vertices are within the rectangle (i.e., |gₓ|<aⱼ and |g_{y}|<bⱼ), then (\tilde{g}ₓ, \tilde{g}_{y}) is set to the average position of the vertices. Otherwise, if an edge has two intersections with the rectangle, the midpoint of the intersections is used.

Using the closest point (\tilde{g}ₓ, \tilde{g}_{y}), the closest distance from the j-th object to the polygonal boundary surrounding waypoint xₖ is represented by Equation (14).

$${d}_{kj} = \{ \begin{matrix}\sqrt{( {( {d}_{kj}^{x} )}^{2} + {( {d}_{kh}^{y} )}^{2} )} , \vert {\tilde{g}}_{x} \vert > {a}_{0} or \vert {\tilde{g}}_{y} \vert > {b}_{0} , \\ {n}^{T} [ \begin{matrix}{\tilde{g}}_{x} - {a}_{j} {s}_{x} \\ {\tilde{g}}_{y} - {b}_{j} {s}_{y}\end{matrix} ] , otherwise\end{matrix} \qquad ( 17 a )$$

### Here,

$${d}_{k j}^{x} = max ( 0 , {\tilde{g}}_{x} - {a}_{j} , - {\tilde{g}}_{x} - {a}_{j} ) and {d}_{k j}^{y} = max ( 0 , {\tilde{g}}_{y} - {b}_{j} , - {\tilde{g}}_{y} - {b}_{j} ) ,$$

and sₓ may be set to sign(\tilde{g}ₓ) and s_{y} may be set to sign(\tilde{g}_{y}). The gradient may be represented by Equation (17b).

$$∇ {d}_{k j} = {[ , , 0 , 0 , cos ( {θ}_{k} ) - sin ( {θ}_{k} ) , 0 ]}^{T} , \qquad ( 17 b )$$

Here, θₖ is the vehicle orientation at waypoint xₖ. The direction vector ñ=(ñ₁, ñ₂) is represented by Equation (18), and n is represented by Equation (19).

$$\tilde{n} = R ( {ψ}_{j} ) n , \qquad ( 18 )$$

$$n = \{ \begin{matrix}\frac{( \overline{{g}_{x}} , \overline{{g}_{y}} )}{\vert ( \overline{{g}_{x}} , \overline{{g}_{y}} ) \vert} , & \vert \vert > {a}_{j} or \vert \vert > {b}_{j} \\ \frac{( {s}_{x} , {s}_{y} )}{\vert ( {s}_{x} , {s}_{y} ) \vert} , & max ( \vert \vert - {a}_{j} \vert , \vert ( \vert - {b}_{j} ) \vert ) \leq ϵ \\ ( {s}_{x} , 0 ) , & \vert \overline{{g}_{x}} / {a}_{j} \vert \leq \vert \overline{{g}_{y}} / {b}_{j} \vert \\ ( 0 , {s}_{y} ) , & otherwise\end{matrix} \qquad ( 19 )$$

In Equation (19), if there is no collision between the j-th object and the equipped vehicle, n represents the direction of the closest point to the object. If there is a collision, the constraint of Equation (14) becomes active, pushing the waypoint in direction n for the next iteration. To achieve effective performance, if (\tilde{g}ₓ, \tilde{g}_{y}) is inside the object, when (\tilde{g}ₓ, \tilde{g}_{y}) falls within distance ϵ of a corner of the object, n is oriented at a 45° angle. Otherwise, n is oriented to distance the waypoint in a direction perpendicular to the closest side of the rectangle. Accordingly, by selecting angles in increments of 45° relative to ψⱼ, the gradient ∇dₖⱼ remains more stable between successive iterations, which reduces oscillation and leads to faster convergence.

The collision avoidance constraints of Equation (13c) are obtained as represented in Equation (20a).

$$M = diag ( {M}_{1} , … , {M}_{N} ) , b = vec ( {b}_{1} , … , {b}_{N} ) ,$$

Here, each sub-matrix Mₖ and column vector bₖ, for k=1 . . . N, is defined according to Equation (20b).

$${M}_{k} = {[ ∇ {d}_{k 1} , … , ∇ {d}_{k J} ]}^{T} , {b}_{k} = {[ {d}_{k 1} , … , {d}_{k J} ]}^{T} . \qquad ( 20 b )$$

Thus, row j in Equation (20b) corresponds to Equation (17) for the j-th object and k-th waypoint.

It is undesirable for a vehicle that includes autonomous driving capabilities to move into an area that has been left unchecked by sensors of the vehicle without determining that no object is present. While sensor placement provides sufficient coverage to detect objects in many scenarios, sensor latency, sensor blockage, and high steering angle may prevent the equipped vehicle from detecting an object. In some situations, sides of the equipped vehicle may enter blind spots when the equipped vehicle performs a turn. Additionally or alternatively, when the equipped vehicle and/or the object is moving, sensors may have insufficient time to distinguish a detection from background noise (i.e., the sensing system of the equipped vehicle may determine a false positive or false negative detection), even within a field of sensing of the sensing system. Moreover, the nearfield zones of a sensor may have limited ability to detect an object or estimate the distance between the object and the equipped vehicle.

Constraints within the vehicular control system may be used to prevent the generated trajectory from guiding the equipped vehicle into blind spots. Implementing the constraints may include using a known spatial map of a field of sensing of a sensor. Accordingly, the vehicular control system may use the known spatial map to maintain a map of regions that remain unchecked by the sensing system at each waypoint in the trajectory. In each iteration of Equation (13a-f), modified bounds constraints are computed to prevent the equipped vehicle from traversing through the unchecked region.

The field of sensing of the sensor is modeled as an image mask, as represented by Equation (21).

$$V ( q ) = \{ \begin{matrix}0 , & if q is a blind spot \\ 1 , & if q is visible\end{matrix} \qquad ( 21 )$$

Here, q=(qₓ, q_{y}) is a coordinate in a local frame of the equipped vehicle. The unchecked region for waypoint k is represented by Equation (22a).

$${U}_{k} ( r ) = 1 - {C}_{k} ( r ) , \qquad ( 22 a )$$

Here, the checked region Cₖ(r) is determined by transforming V(q) relative to waypoint k and computing a union with the previous checked region Cₖ₋₁(r), as represented by Equation (22b).

$${C}_{k} ( r ) = {C}_{k - 1} ( r ) ⋃ V ( {R}_{{θ}_{k}} ( r - {r}_{k} ) ) \qquad ( 22 b )$$

Here, r=(rₓ, r_{y}) is a coordinate in a global frame, rₖ=(xₖ, yₖ) is the position of the vehicle, and R_{θ}_{ₖ}=R(θₖ) is a rotation by vehicle orientation θₖ. The initial C₀ is set to 1 in a region surrounding the equipped vehicle, and C₀ is set to 0 outside of the region surrounding the equipped vehicle. The checked region may be stored in non-transitory memory and updated iteratively.

To compute modified bounds constraints, specific increases or decreases to xₖ, yₖ, and θₖ are determined that would cause the host vehicle's boundary polygon to intersect Uₖ(r). The constraint represented by Equation (13e) is modified so that the limits

$${x}_{k}^{min} and {x}_{k}^{max}$$

depend on k. The new limits are represented by Equations (23a) and (23b).

$${x}_{k}^{min} = max ( {x}^{min} , {x}_{k} - Δ {x}_{k}^{-} ) \qquad ( 23 a )$$

$${y}_{k}^{min} = max ( {y}^{min} , {y}_{k} - Δ {y}_{k}^{-} )$$

$${θ}_{k}^{min} = max ( {θ}^{min} , {θ}_{k} - Δ ∖ {theta}_{k}^{-} )$$

$${x}_{k}^{max} = min ( {x}^{max} , {x}_{k} + Δ {x}_{k}^{+} ) \qquad ( 23 b )$$

$${y}_{k}^{max} = min ( {y}^{max} , {y}_{k} + Δ {y}_{k}^{+} )$$

$${θ}_{k}^{max} = min ( {θ}^{max} , {θ}_{k} + Δ {theta}_{k}^{+} )$$

### Here,

$$Δ {x}_{k}^{\pm } , Δ {y}_{k}^{\pm } , and {Δθ}_{k}^{\pm }$$

are the smallest displacements for the polygon to reach a non-zero in Uₖ(r).

FIG. 3A illustrates a generated trajectory of a path 30 for a rear-in perpendicular parking maneuver, such as reversing the vehicle into a perpendicular parking slot 32. The path 30 of the vehicle is depicted with a marker representing each waypoint and a corresponding rectangle to indicate the position and orientation of the vehicle at each step of the path 30. Here, the “L”-shaped driving region, confined by lines 34, represents four rectangular objects surrounding the parking slot 32. The rectangular objects represent the boundaries of objects proximate to the equipped vehicle. Vehicle boundary 36 represents an initial position of the equipped vehicle before performing the parking maneuver. Vehicular boundary 38 represents the final position of the equipped vehicle after performing the parking maneuver.

FIG. 3B illustrates state and control variables corresponding to the generated trajectory over time t[s]. The plots represent adjustments for a smooth and collision-free trajectory into the perpendicular parking slot 32. Here, x(t) represents the x-coordinate of the position of the vehicle; y(t) represents the y-coordinate of the position of the equipped vehicle; v(t) represents the velocity of the vehicle; a(t) represents the acceleration of the vehicle; θ(t) represents the orientation angle of the vehicle; φ(t) represents the steering angle of a steering system of the equipped vehicle; j(t) represents the jerk (i.e., rate of change of acceleration); and ω(t) represents the steering rate of the equipped vehicle.

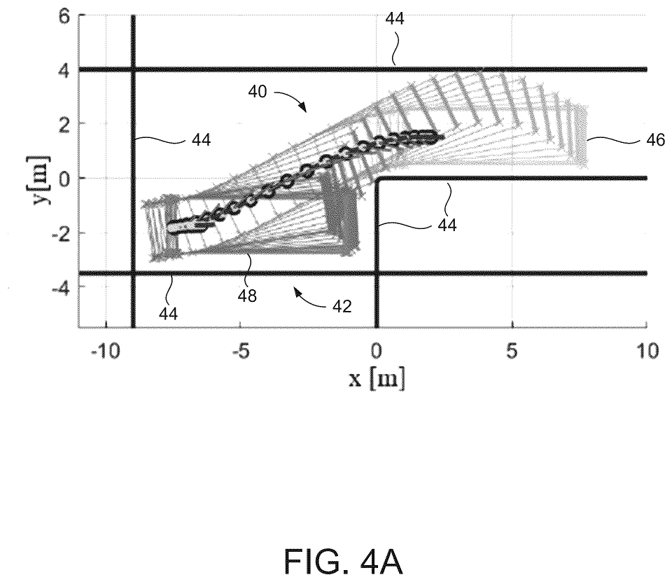

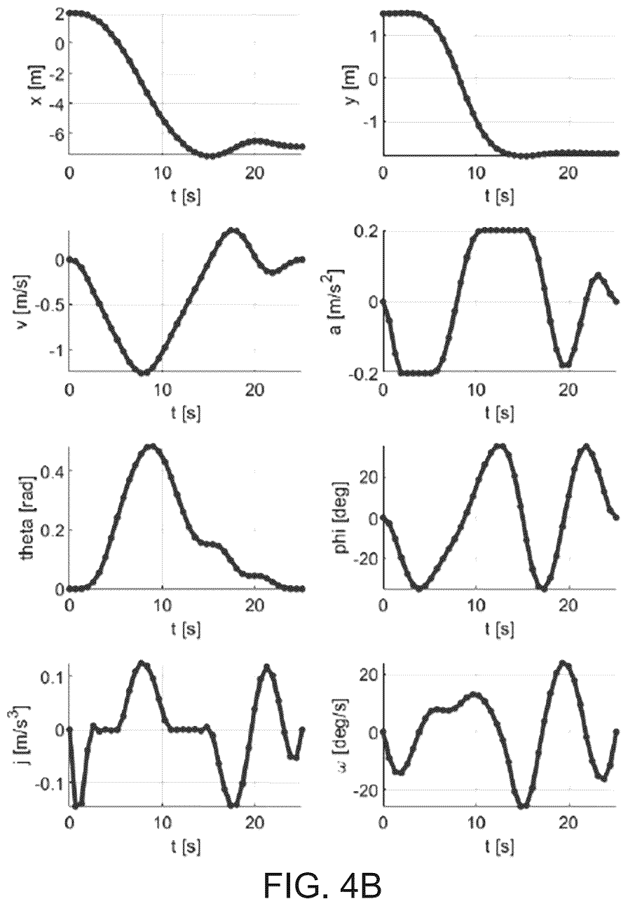

FIG. 4A illustrates a generated trajectory of a path 40 for a rear-in parallel parking maneuver, such as reversing the vehicle into a parallel parking slot 42. Here, the driving region, confined by lines 44, represents four rectangular objects and a curb surrounding the parking slot 42. Vehicle boundary 46 represents an initial position of the equipped vehicle before performing the parking maneuver. Vehicular boundary 48 represents the final position of the equipped vehicle after performing the parking maneuver.

FIG. 4B illustrates state and control variables corresponding to the generated trajectory over time t[s]. The plots represent adjustments for a smooth and collision-free trajectory into the parallel parking slot 42. The plots illustrate adjustments in position, velocity, and steering to align parallel to the curb and fit into the parking slot 42. Specifically, x(t) represents the x-coordinate of the position of the vehicle; y(t) represents the y-coordinate of the position of the equipped vehicle; v(t) represents the velocity of the vehicle; a(t) represents the acceleration of the vehicle; θ(t) represents the orientation angle of the vehicle; φ(t) represents the steering angle of a steering system of the equipped vehicle; j(t) represents the jerk (i.e., rate of change of acceleration); and ω(t) represents the steering rate of the equipped vehicle.

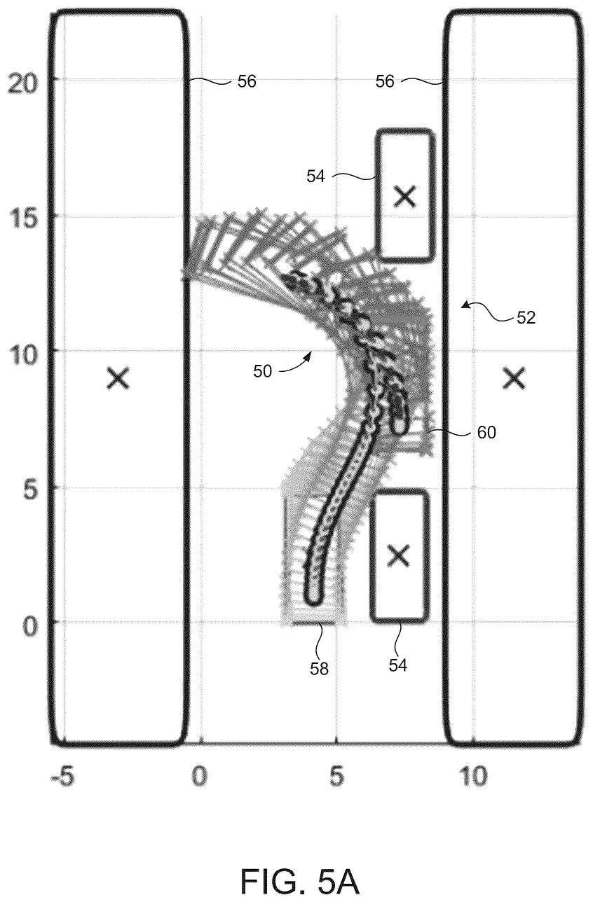

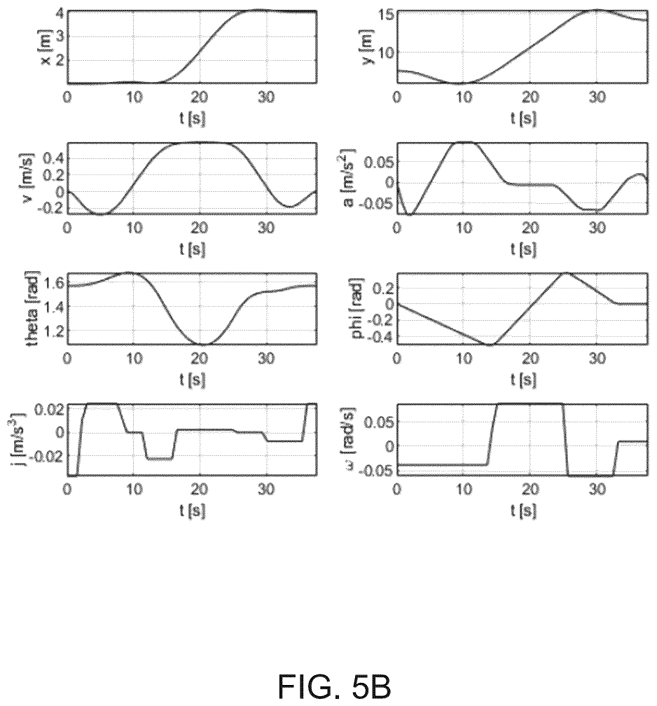

FIG. 5A illustrates a generated trajectory of a path 50 for a parallel park-in maneuver. When moving forward, the equipped vehicle avoids leaving a road along which the vehicle is traveling, before backing into a parking slot 52 between two cars 54. Here, the driving region is confined by lines 56, representing, for example, the edges of the road. Vehicle boundary 58 represents an initial position of the equipped vehicle before performing the parking maneuver. Vehicular boundary 60 represents the final position of the equipped vehicle after performing the parking maneuver.

FIG. 5B illustrates state and control variables corresponding to the generated trajectory over time t[s]. The plots represent adjustments for a smooth and collision-free trajectory into the parallel parking slot 52. The plots illustrate adjustments in position, velocity, and steering to align parallel to the curb and fit into the parking slot 52. Specifically, x(t) represents the x-coordinate of the position of the vehicle; y(t) represents the y-coordinate of the position of the equipped vehicle; v(t) represents the velocity of the vehicle; a(t) represents the acceleration of the vehicle; θ(t) represents the orientation angle of the vehicle; φ(t) represents the steering angle of a steering system of the equipped vehicle; j(t) represents the jerk (i.e., rate of change of acceleration); and ω(t) represents the steering rate of the equipped vehicle.

The vehicular control system including sequential convex optimization effectively generates optimized and collision-free trajectories, such as a trajectory of a path for a parking maneuver. The control system may navigate an equipped vehicle into and out of parking slots while adhering to constraints on state and control variables of the control system.

Accordingly, the vehicular control system including sequential convex optimization may perform optimal trajectory planning. Using sequential convex optimization, efficient and collision-free trajectories may be generated for various parking scenarios. The vehicular control system determines vehicle kinematics, obstacle avoidance, and sensor blind spots, calculating smooth and feasible paths for the equipped vehicle. The vehicular control system may navigate complex parking maneuvers with practical applicability and efficiency. The vehicular control system may be implemented in real-time applications, such as integrating the vehicular control system in a vehicle with autonomous driving capabilities. The vehicular control system may also be integrated with advanced sensor technologies to further enhance the robustness and performance of the vehicular control system.

For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The imaging device and control and image processor and any associated illumination source, if applicable, may comprise any suitable components, and may utilize aspects of the cameras (such as various imaging sensors or imaging array sensors or cameras or the like, such as a CMOS imaging array sensor, a CCD sensor or other sensors or the like) and vision systems described in U.S. Pat. Nos. 5,760,962; 5,715,093; 6,922,292; 6,757,109; 6,717,610; 6,590,719; 6,201,642; 5,796,094; 6,559,435; 6,831,261; 6,822,563; 6,946,978; 7,720,580; 8,542,451; 7,965,336; 7,480,149; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2009/036176; WO 2009/046268; WO 2010/099416; WO 2011/028686 and/or WO 2013/016409, and/or U.S. Publication Nos. US 2010-0020170 and/or US-2009-0244361, which are all hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The system may utilize aspects of the parking assist systems described in U.S. Pat. No. 8,874,317 and/or U.S. Publication Nos. US-2017-0329346; US-2017-0317748; US-2017-0253237; US-2017-0050672; US-2017-0017848; US-2017-0015312 and/or US-2015-0344028, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a sensor disposed at a vehicle equipped with the vehicular driving assist system and sensing exterior of the vehicle, the sensor capturing sensor data;
an electronic control unit (ECU) comprising electronic circuitry and associated software;
wherein sensor data captured by the sensor is transferred to the ECU;
wherein the electronic circuitry of the ECU comprises a processor for processing sensor data captured by the sensor and transferred to the ECU;
wherein the vehicular driving assist system detects, responsive to processing at the ECU of sensor data captured by the sensor, an object in a field of sensing;
wherein the vehicular driving assist system determines, based at least in part on detecting the object, a plurality of waypoints that represents a reference trajectory of the vehicle;
wherein the vehicular driving assist system determines, for each waypoint of the plurality of waypoints, a constraint with respect to the detected object; and
wherein the vehicular driving assist system adjusts, based at least in part on the constraints with respect to the detected object, the reference trajectory of the vehicle to determine an updated trajectory of the vehicle.

2. The vehicular driving assist system of claim 1, wherein each waypoint of the plurality of waypoints is associated with a boundary surrounding the respective waypoint, and wherein each boundary represents a length and a width of the vehicle, and wherein the vehicular driving assist system determines, for adjacent boundaries associated with adjacent waypoints, a convex hull representing an interpolated path of the vehicle between the adjacent boundaries.

3. The vehicular driving assist system of claim 2, wherein the vehicular driving assist system determines, for each boundary, a closest point between the boundary and the detected object, and wherein the constraint associated with the waypoint of the respective boundary is determined based at least in part on the closest point between the respective boundary and the detected object.

4. The vehicular driving assist system of claim 2, wherein the vehicular driving assist system determines that a respective boundary intersects with the detected object, and wherein the ECU relocates, based on determining that the respective boundary intersects with the detected object, the waypoint of the respective boundary to a position further away from the detected object.

5. The vehicular driving assist system of claim 4, wherein the vehicular driving assist system determines that the determined intersection is within a threshold distance from a corner of the detected object, and wherein the ECU relocates, based on determining that the determined intersection is within the threshold distance from the corner of the detected object, the waypoint associated with the respective boundary at a 45 degree angle away from the detected object.

6. The vehicular driving assist system of claim 2, wherein the boundary of the vehicle is defined by a wheelbase, a front overhang, and a rear overhang of the vehicle.

7. The vehicular driving assist system of claim 1, wherein the object comprises a plurality of objects, and wherein the vehicular driving assist system determines, for each waypoint of the plurality of waypoints, a constraint for each detected object of the plurality of objects.

8. The vehicular driving assist system of claim 1, wherein the vehicular driving assist system controls, based on the updated trajectory, lateral movement of the vehicle.

9. The vehicular driving assist system of claim 1, wherein the vehicular driving assist system controls, based on the updated trajectory, a velocity of the vehicle.

10. The vehicular driving assist system of claim 1, wherein the electronic control unit adjusts the reference trajectory by iteratively linearizing a non-convex optimization problem to solve a sequence of convex sub-problems.

11. The vehicular driving assist system of claim 1, wherein the updated trajectory minimizes a total elapsed time for the vehicle to reach a final destination.

12. The vehicular driving assist system of claim 1, wherein the reference trajectory is defined by a state vector comprising a steering angle and a velocity, and wherein the vehicular driving assist system adjusts the reference trajectory based at least in part on a control input vector comprising a steering rate and a jerk.

13. The vehicular driving assist system of claim 1, wherein the electronic control unit penalizes, via a weighted norm, adjustments to the reference trajectory that exceed a threshold distance from a trajectory determined in a previous optimization iteration.

14. A vehicular driving assist system, the vehicular driving assist system comprising:
a sensor disposed at a vehicle equipped with the vehicular driving assist system and sensing exterior of the vehicle, the sensor capturing sensor data;
an electronic control unit (ECU) comprising electronic circuitry and associated software;
wherein the electronic circuitry of the ECU comprises a processor for processing sensor data captured by the sensor to detect objects present within a field of sensing of the sensor;
wherein the vehicular driving assist system determines, responsive to processing at the ECU of sensor data captured by the sensor, a region within the field of sensing;
wherein the vehicular driving assist system determines a plurality of waypoints that represents a reference trajectory of the vehicle;
wherein the vehicular driving assist system determines, for each waypoint of the plurality of waypoints, a constraint with respect to the determined region representing the field of sensing; and
wherein the vehicular driving assist system adjusts, based at least in part on the constraint with respect to the determined region, the reference trajectory of the vehicle to determine an updated trajectory of the vehicle.

15. The vehicular driving assist system of claim 14, wherein the vehicular driving assist system determines a minimum displacement along a coordinate axis that causes a boundary of the vehicle at a respective waypoint to reach an unchecked region exterior to the determined region, and wherein the vehicular driving assist system adjusts, based on the determined minimum displacement, the constraint.

16. The vehicular driving assist system of claim 14, wherein the vehicular driving assist system determines a minimum change in vehicle orientation that causes a boundary of the vehicle at the respective waypoint to reach an unchecked region exterior to the determined region, and wherein the vehicular driving assist system adjusts, based on the determined minimum change in orientation, the constraint.

17. The vehicular driving assist system of claim 14, wherein the vehicular driving assist system models the determined region representing the field of sensing with an image mask.

18. The vehicular driving assist system of claim 14, wherein the vehicular driving assist system controls, based on the updated trajectory, lateral movement of the vehicle.

19. The vehicular driving assist system of claim 14, wherein the vehicular driving assist system controls, based on the updated trajectory, a velocity of the vehicle.

20. The vehicular driving assist system of claim 14, wherein the determined region within the field of sensing comprises a cumulative checked region determined by computing a union of a current field of sensing of the sensor with a previously checked region.
